(19) United States
(12) Patent Application Publication
(10) Pub. No.: US 2011/0098007 A1
(43) Pub. Date: Apr. 28, 2011

(54) METHODS AND APPARATUSES FOR TUNING FILTERS

(75) Inventor: Olivier Charlon, San Francisco, CA (US)

(73) Assignee: NXP B.V., Eindhoven (NL)

(21) Appl. No.: 11/817,792

(22) PCT Filed: Mar. 2, 2006
(86) PCT No.: PCT/IB06/50665

§ 371 Date: Jun. 12, 2009

Related U.S. Application Data
(60) Provisional application No. 60/658,249, filed on Mar. 2, 2005.

(51) Int. Cl. H04B 1/40

(52) U.S. Cl. 455/77

(57) ABSTRACT

Systems and methods according to the present invention address this need and others by providing filter tuning methods and apparatuses which directly measure filter attenuation by transmitting signaling tones through the filter(s). The measured attenuation is compared with the desired frequency response of the filter. The result of the comparison is used to tune the filter(s).

The present invention relates generally to filters and, more particularly, to systems and methods for tuning filters which can be used, for example, in radio communication devices.

Technologies associated with the communication of information have evolved rapidly over the last several decades. For example, over the last two decades wireless communication technologies have transitioned from providing products that were originally viewed as novelty items to providing products which are the fundamental means for mobile communications. Perhaps the most influential of these wireless technologies were cellular telephone systems and products. Cellular technologies emerged to provide a mobile extension to existing wireline communication systems, providing users with ubiquitous coverage using traditional circuit-switched radio paths. More recently, however, wireless communication technologies have begun to replace wireline connections in almost every area of communications. Wireless local area networks (WLANs) are rapidly becoming a popular alternative to the conventional wired networks in homes, offices and public places (e.g., cafes, food chain restaurants, airports, aircrafts, etc.).

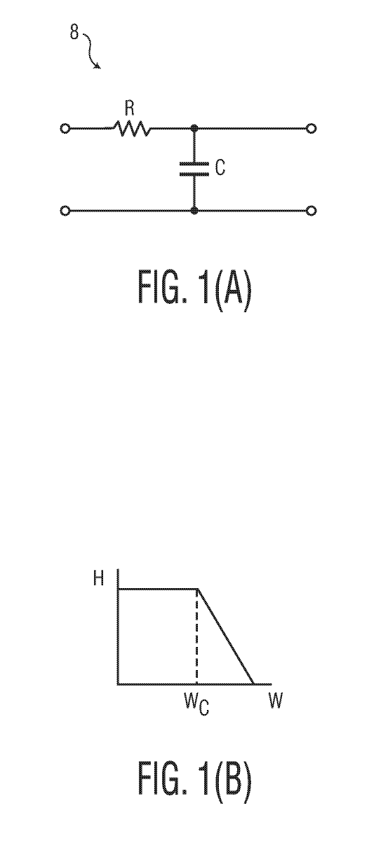

Filters are used in many different applications in communication technologies to, for example, exclude signal energy associated with one or more spectral ranges from a signal being processed. Such filters can be used, for example, to remove images created by upconversion or downconversion of a signal or to limit a signal to a frequency band within which a communication channel is defined to exist. Such filters can also be used to remove interferer signals due to adjacent channels or any un-wanted out-of-band signals. An exemplary RC low-pass filter is shown in FIG. 1(a). This filter operates to attenuate frequencies as shown by the plot of FIG. 1(b), wherein the corner frequency ωc of the filter 8 is equal to 1/RC.

Variations in process and temperature result in the resistance and capacitance values associated with the resistor R and the capacitor C used to fabricate a filter being different from their design specifications, resulting in a shift in the corner frequency. If these variations are significant enough, the filter may attenuate desired signals or, conversely, fail to attenuate interfering signals. Accordingly, filter tuning circuits are employed to adjust the resistance and/or capacitance values associated with filter circuits to bring those values within specified design ranges. One technique employed by filter tuning circuits is to measure the actual RC time constant associated with a filter being tuned and to compare the measured value with the design value. This technique can be performed by, for example, measuring the charge time of a resistive, dependent current into a capacitor or by charging an RC network and measuring the decay of the charge. In either case time periods are measured using an accurate timing reference, e.g., a crystal oscillator reference, and compared to the design specification for RC. The desired RC value is then obtained by, for example, varying the capacitance value C (using a variable capacitor in the filter).

Such a solution to filter tuning relies strongly on matching between the filter and the measurement circuit's RC time constants. Moreover, these techniques also rely on the accuracy of the timing reference available in the device. Additionally, these techniques require time to measure the RC time constant prior to tuning the filter, which time results in additional power consumption in the device.

Accordingly, it would be desirable to develop techniques and devices for tuning filters which overcome the aforedescribed drawbacks.

Systems and methods according to the present invention address this need and others by providing filter tuning methods and apparatuses which directly measure filter attenuation by transmitting signaling tones through the filter(s). The measured attenuation is compared with the desired frequency response of the filter. The result of the comparison is used to tune the filter(s).

According to one exemplary embodiment of the present invention, a method for tuning a filter includes the steps of generating a plurality of tones, filtering the plurality of tones using a transmit filter to generate a first filtered signal, looping the first filtered signal back through a receive portion of the transceiver, filtering the first filtered signal using a receive filter to generate a second filtered signal, determining an attenuation associated with the plurality of tones in the second filtered signal, and selectively tuning at least one of the transmit filter and the receive filter based on the attenuation.

According to another exemplary embodiment of the present invention, a transceiver includes a filter and a digital signal processor for generating at least one signaling tone and sending the at least one signaling tone through the filter, wherein the digital signal processor measures an attenuation associated with an output of the at least one signaling tone from the filter, compares the measured attenuation with a desired attenuation and adjusts the filter based on a result of the comparison.

According to yet another exemplary embodiment of the present invention, a method for tuning a filter comprises the steps of transmitting at least one signaling tone through a filter, measuring an attenuation associated with an output of the at least one signaling tone from said filter, comparing the measured attenuation with a desired attenuation and adjusting said filter based on a result of the comparing step.

The accompanying drawings illustrate exemplary embodiments of the present invention, wherein:

FIG. 1(a) illustrates a low-pass RC filter;

FIG. 1(b) illustrates a transfer function associated with the RC filter of FIG. 1(a);

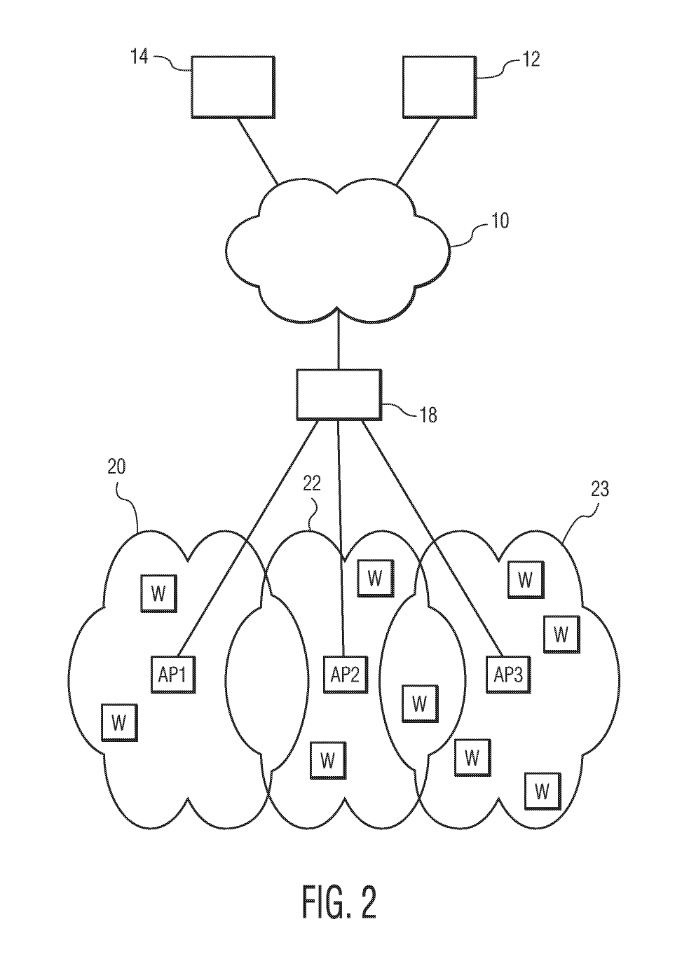

FIG. 2 depicts an exemplary WLAN system in which techniques for tuning filters can be employed according to an exemplary embodiment of the present invention;

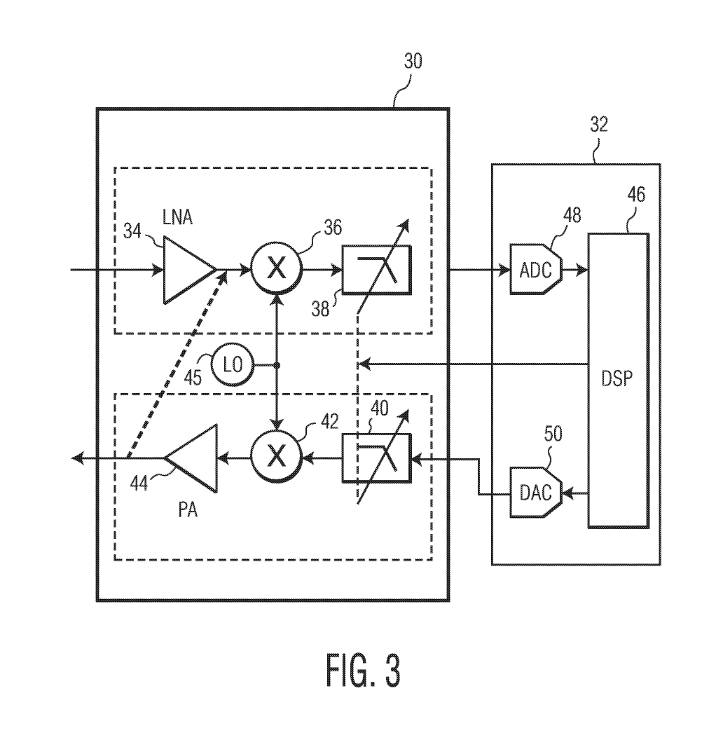

FIG. 3 illustrates a transceiver according to an exemplary embodiment of the present invention;

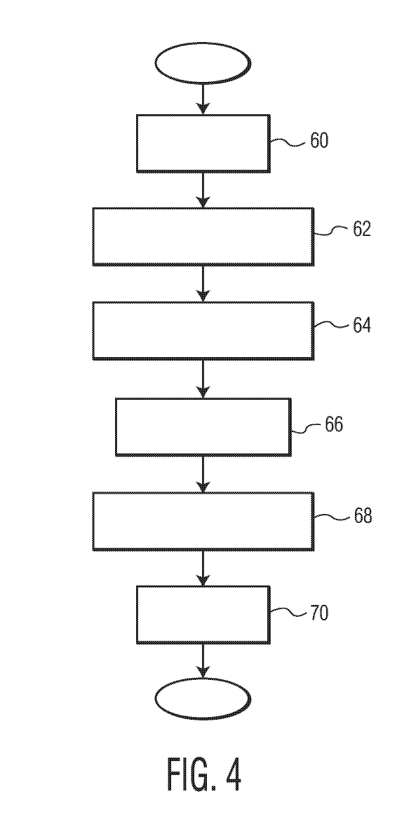

FIG. 4 illustrates a method for tuning filters according to an exemplary embodiment of the present invention; and

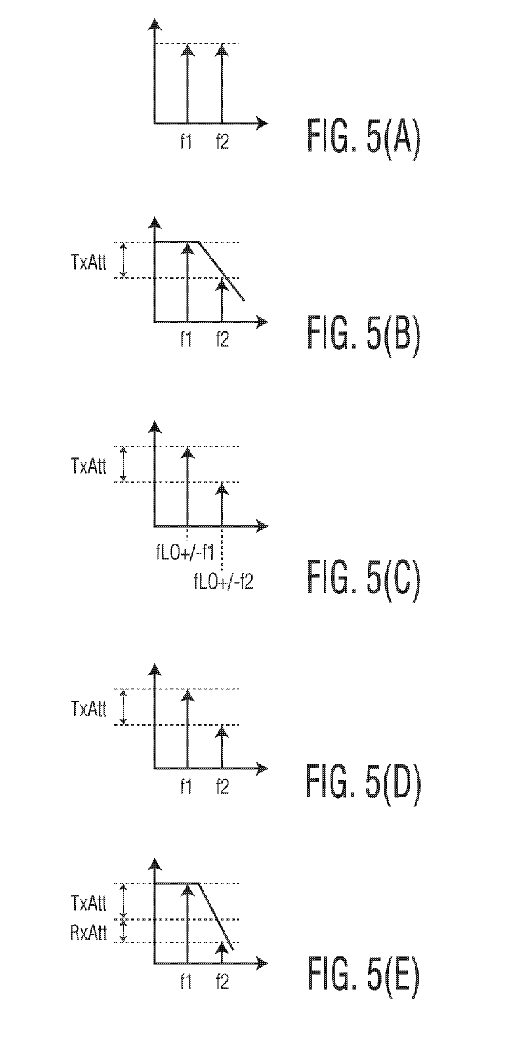

FIGS. 5(a)-5(e) depict signaling tones used to tune filters at various stages of signal processing within the transceiver of FIG.3 according to an exemplary embodiment of the present invention.

The following detailed description of the invention refers to the accompanying drawings. The same reference numbers in different drawings identify the same or similar elements. Also, the following detailed description does not limit the invention. Instead, the scope of the invention is defined by the appended claims.

In order to provide some context for this discussion, an exemplary WLAN system will first be described with respect to FIG. 2. Those skilled in the art will appreciate, however, that the present invention is not restricted to implementation in WLAN systems and can be used in many different devices and systems, including, for example, radio frequency (RF) applications, cellular applications, Bluetooth applications and other applications in which analog filters are employed. Therein, a wireline network 10 (e.g., an Ethernet network) has a file server 12 and workstation 14 connected thereto. Those skilled in the art will appreciate that typical wireline networks will serve numerous fixed workstations 14, however only one is depicted in FIG. 2 for simplicity. The wireline network 10 is also connected to a WLAN 16 via router 18. The router 18 interconnects the access points (AP) of the WLAN 16 with the wireline network, through which the access points can, for example, communicate with the file server 12. In the exemplary WLAN system of FIG. 2, three cells 20, 22 and 23 (also sometimes referred to as a Basic Service Set (BSS) or Basic Service Area (BSA) are shown each with a respective AP, although those skilled in the art will once again appreciate that more or fewer cells may be provided in WLAN 16. Within each cell, a respective AP serves a number of wireless stations (W) via a wireless connection.

According to exemplary embodiments of the present invention, the transmission of signals between APs and respective wireless stations W is performed using wireless communication signals in accordance with one of the 802.11 standards. However, those skilled in the art will appreciate that the present invention is not so limited and may be used with in conjunction with the communication of signals in accordance with other formats and standards, as well as applications other than communications. A portion of an exemplary transceiver is shown in FIG. 3. Therein, a portion of the circuitry is provided on an analog integrated circuit (IC) 30 and another portion of the circuitry is provided on a digital integrated circuit 32. More specifically, the analog IC 30 includes a low noise amplifier (LNA) 34, a down-mixer 36 and a receive filter 38, which form a part of the receive signal chain, and a transmit filter 40, an up-mixer 42 and a power amplifier (PA) 44, which form part of the transmit signal chain. Additionally, the analog IC 30 includes a local oscillator 45 which provides carrier frequency references to the mixers 36 and 42. The digital IC 32 includes a digital signal processor (DSP) 46 for performing baseband signal processing tasks associated with data to be transmitted and received data, as well as an analog-to-digital converter (ADC) 48 in the receive signal chain and a digital-to-analog converter (DAC) 50 in the transmit signal chain.

According to an exemplary embodiment of the present invention the attenuation of the filters 38 and 40 can be directly measured by transmitting signaling tones through the filters. The measured attenuation is compared with the desired frequency response of the filters. The result of the comparison is then used to tune the filters 38 and 40, e.g., by varying a capacitance associated with either or both of the filters 36 and 40. A method for filter tuning according to an exemplary embodiment of the present invention is illustrated in the flow chart of FIG. 4. Therein, at step 60, a plurality of signal tones are generated by the DSP 46. According to one exemplary embodiment two tones at frequencies f1 and f2, respectively, can be generated. One frequency f1 can, for example, be selected to be in-band i.e., lower than the corner frequency, such that it should not be attenuated by the filters 38 and 40. The other frequency f2 can be selected to be out-of-band, e.g., higher than f1 in a frequency range wherein the filters 36 and 38 provide a few dBs of attenuation. FIG. 5(a) conceptually illustrates the two tones at generation according to an exemplary embodiment of the present invention. The two signal tones can have the same amplitude or different amplitudes as long as the amplitude at generation is known. Additionally, more or fewer than two signal tones can be generated at step 60.

The signal tones are then sent by the DSP 46 through the DAC 50 and are then filtered by the transmit filter 40 as indicated by step 62 in FIG. 4. This has the effect of attenuating at least one of the tones, e.g., the second signal tone f2 as shown in FIG. 5(b), by an amount TxAtt. The signal tones then pass through the up-mixer 42 and power amplifier 44 whereafter the upconverted tones will be in the carrier frequency band as shown by FIG. 5(c). According to one exemplary embodiment of the present invention, the two signal tones can then be looped back through the receive chain (step 64) using a loop-back circuit represented by the dotted line connecting the output of the PA 44 and the input to the down-mixer 36 in FIG. 3. Then the two signal tones are down-converted by mixer 36 to their original tone frequencies f1 and f2 as indicated by FIG. 5(d).

After down-conversion, the two signal tones are filtered by the receive filter 38 as indicated by step 66 in FIG. 4. This introduces additional attenuation RxAtt to at least one of the signal tones, in this example the second signal tone f2, as shown in FIG. 5(e). The output of the receive filter 38 is presented to the digital IC 32 for A-to-D conversion by

ADC 48 and processing by the DSP 50. The DSP 50 determines the total attenuation (TxAtt+RxAtt). If the total attenuation associated with transmission of the tones through the transmit and receive chain is greater than that of the cascaded design values for the receive and transmit filter attenuation, then the filter corner frequency associated with one or both of the receive and transmit filters 38 and 40 can be increased. This can be accomplished by the DSP 50 adjusting tunable capacitors (not shown in FIG. 3). Conversely, if the total attenuation associated with transmission of the tones through the transmit and receive chain is less than that of the cascaded design values for the receive and transmit filter attenuation, then the filter corner frequency associated with one or both of the receive and transmit filters 38 and 40 can be decreased.

Since it may not be possible to characterize the gain associated with the components in the transmit and receive signal processing chains, one of the signal tones (f1 in this example) can act as a control for processing by DSP 50. Thus, the total attenuation of signal tone f2 is calculated, for example, as relative to the attenuation of signal tone f1 rather than as an absolute value. If, on the other hand, it is possible to characterize the gain of the system with reasonable accuracy, then a single tone f2 could be used instead of two tones.

Other variations in accordance with techniques for tuning filters according to the present invention are also contemplated. For example, the output of the transmit filter 40 could be selectively routed directly to the input or the output of the receive filter 38. This would enable tuning of the transmit filter 40 directly without subjecting the signal tones to upconversion and downconversion, resulting in further power savings to the arrangement since the other signal processing components can be powered down during the filter tuning process.

The above-described exemplary embodiments are intended to be illustrative in all respects, rather than restrictive, of the present invention. Thus the present invention is capable of many variations in detailed implementation that can be derived from the description contained herein by a person skilled in the art. For example, although hardware devices are described in the exemplary embodiments set forth above, those skilled in the art will appreciate that all, or portions of, the functionality described above can instead be implemented in software. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for tuning a filter in a transceiver comprising the steps of:
generating a plurality of tones;
filtering said plurality of tones using a transmit filter to generate a first filtered signal;
looping said first filtered signal back through a receive portion of said transceiver;
filtering said first filtered signal using a receive filter to generate a second filtered signal;
determining an attenuation associated with said plurality of tones in said second filtered signal; and
selectively tuning at least one of said transmit filter and said receive filter based on said attenuation.

2. The method of claim 1, further comprising the steps of:
upconverting said first filtered signal to generate an upconverted signal;
amplifying said upconverted signal to generate an amplified signal; and
downconverting said amplified signal prior to generating said second filtered signal.

3. The method of claim 1, wherein said step of generating a plurality of tones further comprises the step of:
generating a first tone at a first frequency which is outside of a frequency range within which said transmit filter and said receive filter are intended to attenuate a signal; and
generating a second tone at a second frequency which is inside of said frequency range.

4. The method of claim 1, wherein said plurality of tones have a same amplitude.

5. The method of claim 1, wherein said plurality of tones have a different amplitude.

6. A method for tuning a filter comprising the steps of:
transmitting at least one signaling tone through a filter;
measuring an attenuation associated with an output of said at least one signaling tone from said filter;
comparing the measured attenuation with a desired attenuation; and
adjusting said filter based on a result of the comparing step.

7. The method of claim 6, wherein said at least one signaling tone includes two tones.

8. The method of claim 7, further comprising the steps of:
generating a first tone at a first frequency which is outside of a frequency range within which said are intended to attenuate a signal; and
generating a second tone at a second frequency which is inside of said frequency range.

9. The method of claim 7, wherein said two tones have a same amplitude.

10. The method of claim 7, wherein said two tones have a different amplitude.

11. A transceiver comprising:
a filter; and
a digital signal processor for generating at least one signaling tone and sending said at least one signaling tone through said filter;
wherein said digital signal processor measures an attenuation associated with an output of said at least one signaling tone from said filter, compares the measured attenuation with a desired attenuation; and adjusts said filter based on a result of the comparison.

12. The transceiver of claim 11, wherein said at least one signaling tone includes two tones.

13. The transceiver of claim 12, further wherein said digital signal processor generates a first tone at a first frequency which is outside of a frequency range within which said filter is intended to attenuate a signal and generates a second tone at a second frequency which is inside of said frequency range.

14. The transceiver of claim 12, wherein said two tones have a same amplitude.

15. The transceiver of claim 12, wherein said two tones have a different amplitude.
